(19) United States
(12) Patent Application Publication
(10) Pub. No.: US 2015/0305112 A1
(43) Pub. Date: Oct. 22, 2015

(54) OPERATING DEVICE FOR ILLUMINANT

(71) Applicant: TRIDONIC GMBH & CO KG, Dornbirn (AT)

(72) Inventors: Dietmar KLIEN, Mader (AT); Oliver WYNNYCZENKO, Lustenau (AT)

(73) Assignee: TRIDONIC GMBH & CO KG, Dornbirn (AT)

(21) Appl. No.: 14/647,424

(22) PCT Filed: Dec. 6, 2013
(86) PCT No.: PCT/AT2013/000197

§ 371 Date: May 26, 2015

(30) Foreign Application Priority Data
Dec. 6, 2012 (AT) GM 461/2012
Dec. 6, 2012 (DE) 102012023934.3

(51) Int. Cl. H05B 33/08

(52) U.S. Cl. CPC H05B 33/0887; H05B 33/0824

(57) ABSTRACT

An operating device (50) for an illuminant comprises an emitted interference suppression unit (59) and an anti-glow-discharge element (70) for suppressing glow discharging from the illuminant. The anti-glow-discharge element (70) is coupled to the emitted interference suppression unit (59).

### FIELD OF THE INVENTION

The invention relates to operating devices for illuminants and to methods for suppressing glow discharge of an illuminant. The invention relates in particular to operating devices and methods in which the operating device has a radio interference suppression element.

### BACKGROUND

Energy-saving luminaires can use light-emitting diodes (LEDs) as illuminants. Such illuminants can also be excited for illumination by low currents. When using luminaires having light-emitting diodes as illuminants, the effect can occur whereby the luminaire continues to illuminate even in a switched-off state. This effect can occur, for example, as so-called ghost light once the luminaire has been switched off. In general, the illuminant emitting light in a switched-off state is referred to here as glow discharge. A cause for such a glow discharge may consist in line capacitances or capacitive coupling within the operating device, but also in other capacitive or inductive couplings, for example.

While a glow discharge of the switched-off luminaire may be desirable in some applications, it can often be perceived as being undesirable.

The object of the invention consists in providing an operating device for an illuminant and a method with which the glow discharge of an illuminant can be effectively suppressed, i.e. reduced, when the luminaire is in a switched-off state.

This object is achieved by an operating device, a method and a lighting system having the features specified in the independent claims. The dependent patent claims define developments of the invention.

### SUMMARY

An operating device for an illuminant in accordance with an exemplary embodiment comprises a radio interference suppression element and a device for suppressing glow discharge of the illuminant, which device is coupled to the radio interference suppression element. The device for suppressing glow discharge which can reduce or completely eliminate glow discharge is also referred to below as anti-glow discharge device.

By virtue of the anti-glow discharge device in the operating device, glow discharge which is caused by capacitances of the radio interference suppression element, for example, can be reduced. Since the anti-glow discharge device is provided in the operating device for the illuminant, the use of a separate unit for residual light suppression, which is connected between the operating device and the illuminant, for example, is no longer required. Correspondingly, the losses which can be brought about by such a separate unit between the operating device and the illuminant can also be avoided. The configuration according to the invention also enables dimming, for example by virtue of pulse width modulation.

The anti-glow discharge device can be configured to influence a current flow to or from the radio interference suppression element. The anti-glow discharge device can be configured to influence the current flow to or from the radio interference suppression element depending on the operating state. The anti-glow discharge device can be configured to reduce a current flow between the radio interference suppression element and ground if the operating device is in a standby mode and/or if the luminaire is switched off.

The anti-glow discharge device can comprise a controllable switching means, which is connected between the radio interference suppression element and ground. The anti-glow discharge device can be connected in series with the radio interference suppression element. The switching means can comprise a transistor, for example a field-effect transistor (FET).

The operating device can be configured in such a way that the controllable switching means is switched to an on state and/or an off state depending on the operating state. The operating device can be configured in such a way that the controllable switching means between the radio interference suppression element and ground is switched to an off state when the luminaire is switched off and/or the operating device is in a standby mode. The operating device can be configured in such a way that the controllable switching means between the radio interference suppression element and ground is switched to an on state when the luminaire is switched on.

The controllable switching means can be coupled to a microcontroller, a controller or a processor or another integrated semiconductor circuit, which is provided on a secondary site of the operating device. The controllable switching means can be interconnected in such a way that it is switched selectively to an on state by the microcontroller, the controller, the processor or the other integrated semiconductor circuit. It is thus possible to ensure that the radio interference suppression element is disconnected when the operating device is in a standby mode and the microcontroller is not being supplied energy on the secondary side. Alternatively or in addition, the controllable switching means can be switched to an on state by a voltage of a secondary side of the operating device.

In the standby mode of the operating device, signals at the supply voltage frequency which can result in an undesired glow discharge can be blocked.

The operating device can have a primary side and a secondary side. The radio interference suppression element can be a radio interference suppression capacitor between the primary side and the secondary side. In this case, a circuit which is formed by the radio interference suppression capacitor can be interrupted by the anti-glow discharge device. For example, such a circuit can be produced by virtue of the fact that discharge currents at the supply voltage frequency occur as a result of a coupling capacitance between an LED module and a grounded luminaire housing. A corresponding circuit can be formed by the voltage between the phase conductor and ground on a primary side of the operating device, by the radio interference suppression capacitor and a coupling capacitance between the LED module and ground. By virtue of the anti-glow discharge device, the radio interference suppression capacitor can be disconnected selectively, and this circuit can be interrupted in order to reduce or completely eliminate the glow discharge of the illuminant.

The anti-glow discharge device can be arranged on the secondary side of the operating device. The anti-glow discharge device can be provided between a radio interference suppression capacitor and a ground of the secondary side of the operating device.

The operating device can be configured as an LED converter. The operating device can be configured as an insulated LED converter.

In accordance with a further exemplary embodiment, a lighting system is specified. The lighting system comprises an operating device as claimed in one exemplary embodiment of the invention. The lighting system comprises a supply source connected to the operating device and an illuminant connected to the operating device.

In accordance with a further exemplary embodiment, a method for suppressing glow discharge of an illuminant is specified. The illuminant is coupled to an operating device, which has a radio interference suppression element. The method comprises influencing of a current flow to or from the radio interference suppression element depending on an operating state of the operating device and/or depending on a signal frequency.

Additional features of the method in accordance with exemplary embodiments and the effects achieved in each case thereby correspond to the additional features of operating devices in accordance with the exemplary embodiments.

In the method, a switching means on a secondary side of the operating device can be controlled in order to suppress a current flow to and from the radio interference suppression element depending on an operating state. The switching means can be arranged between the radio interference suppression element and ground. By virtue of the switching means, the radio interference suppression element can be connected selectively when the illuminant is intended to be supplied energy by the operating device. The radio interference suppression element can be selectively disconnected when the illuminant is not intended to be supplied energy.

The method can be implemented using the operating device in accordance with one exemplary embodiment. In particular, the operating device can be an LED converter.

Further features, advantages and functions of exemplary embodiments of the invention become apparent from the detailed description below with reference to the attached drawings, in which identical or similar reference symbols denote units having an identical or similar function.

### BRIEF DESCRIPTION OF THE DRAWINGS

FIG. 1 shows an illumination system comprising an operating device for an illuminant in accordance with one exemplary embodiment of the invention.

FIG. 2 shows a block diagram of an operating device in accordance with one exemplary embodiment.

FIG. 3 shows a circuit diagram of an anti-glow discharge device for an operating device in accordance with one exemplary embodiment.

FIG. 4 shows a circuit diagram of an operating device comprising an anti-glow discharge device in accordance with one exemplary embodiment.

FIG. 5 shows a flowchart for a method in accordance with one exemplary embodiment.

### DETAILED DESCRIPTION OF THE PREFERRED EMBODIMENTS

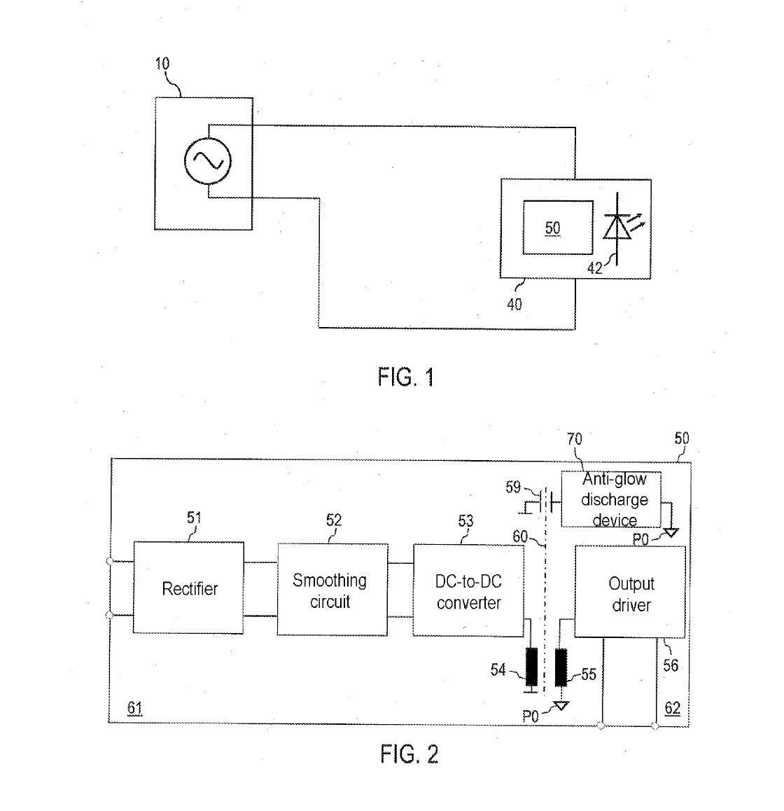

FIG. 1 illustrates a lighting system comprising an operating device for an illuminant in accordance with one exemplary embodiment of the invention. The lighting system comprises a supply source 10, for example a mains voltage source, and a luminaire 40 or a plurality of luminaires 40. The luminaire 40 has an operating device 50 in accordance with one exemplary embodiment and an illuminant 42. The illuminant 42 can comprise one or more light-emitting diodes (LEDs). Correspondingly, the operating device 50 can be configured as an LED converter. The illuminant 42 can be implemented in a variety of ways, for example by one or more inorganic LEDs, organic LEDs, other illuminants or a combination of the mentioned types of illuminant. Suitable operation of the respective illuminant 42 is performed via the operating device 50. For this purpose, the operating device 50 can comprise a switched mode power supply, for example, which generates a suitable voltage and/or a suitable current for operating the illuminant 42 from a supply voltage supplied to the luminaire 40. A housing of the luminaire 40 can be grounded.

As is described in yet more detail with reference to FIG. 2 to FIG. 5, the operating device 50 has a radio interference suppression element and an anti-glow discharge device for suppressing glow discharge. Glow discharge of the illuminant 42 can be reduced or completely eliminated by the anti-glow discharge device by current being conducted to or from the radio interference suppression element in a manner dependent on the operating state and/or frequency when the luminaire 40 is switched off and/or when the operating device 50 is in a standby mode. The anti-glow discharge device can comprise a switching means. The switching means can be provided in such a way that it is switched selectively only to an on state in order to connect a radio interference suppression capacitor when the luminaire 40 is switched on. The switching means can be coupled to a secondary coil of a converter of the operating device.

FIG. 2 shows a block diagram illustration of an operating device 50 in accordance with one exemplary embodiment. The operating device 50 can operate as constant current source or constant voltage source. The operating device 50 can be an LED converter. The operating device 50 can be an insulated LED converter.

The operating device 50 has a rectifier 51 on the input side. The rectified supply voltage at the input of the operating device can be smoothed by a smoothing circuit 52 (also referred to as power factor correction circuit or PFC circuit). By virtue of the smoothing circuit 52, power factor correction can take place in such a way that the total harmonic distortion (THD) is reduced and the power factor is increased. A DC-to-DC converter 53 can be controlled by a control device, for example a microcontroller, controller, processor or another integrated semiconductor circuit on a primary side of the operating device. The DC-to-DC converter can have an LLC resonant converter, a flyback converter or another converter topology. The operating device can comprise a transformer having a primary-side coil 54 and a secondary-side coil 55 coupled inductively thereto. The primary-side coil 54 is arranged on a primary side 61 of the operating device 50. The secondary-side coil 55 is arranged on a secondary side 62 of the operating device 50. The transformer can produce galvanic isolation. The secondary side 62 can be an SELV (safety extra-low voltage) side of the operating device, which is isolated from the primary side 61 by an SELV barrier 60 or other galvanic isolation. An output driver 56 can be coupled to the secondary-side coil 55. Outputs of the operating device 50 can be electrically conductively connected to the illuminant 42, for example to an LED module. The operating device 50 can also have, for example, only one DC-to-DC converter 53; the rectifier 51, the smoothing circuit 52 and the output driver 56 are optional elements whose function is also integrated in the DC-to-DC converter 53.

The operating device 50 has a radio interference suppression element. In the configuration illustrated, the radio interference suppression element is configured as a radio interference suppression capacitor 59. The radio interference suppression capacitor 59 is connected between the primary side 61 and the secondary side 62. At least in useful operation when the luminaire 40 is switched on, radiofrequency interference signals can be discharged from the mains and lamp lines by the radio interference suppression capacitor 59. As a result, electromagnetic interference can be reduced, for example. The radiofrequency interference signals can be caused, for example, from the operation of one or more on-off controllers, for example of the DC-to-DC converter 53 or other components of the operating device 50.

The operating device 50 has an anti-glow discharge device 70. The anti-glow discharge device 70 is coupled to the radio interference suppression element. The anti-glow discharge device 70 can be configured to influence, for example to selectively block, currents between the radio interference suppression element and a ground potential P0. This can take place depending on an operating state of the luminaire or the operating device. As an alternative or in addition, the current flow between the radio interference suppression element and a ground potential P0 can be blocked in frequency-dependent fashion. The anti-glow discharge device 70 can be configured in such a way that it blocks or damps currents at a frequency of the supply voltage which is supplied to the operating device at least when the luminaire 40 is switched off and/or the operating device 50 is in a standby mode. The anti-glow discharge device 70 can be configured in such a way that currents can flow between the radio interference suppression element 59 and the ground potential P0 at a radio interference suppression frequency at least when the luminaire 40 is switched on.

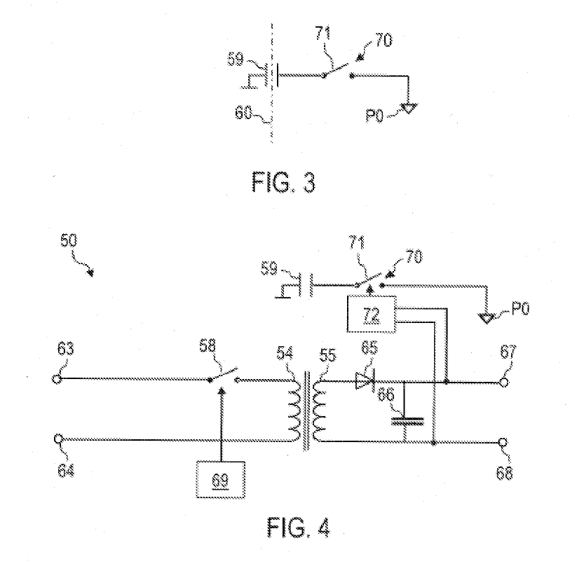

With reference to FIG. 3 to FIG. 5, configurations of the anti-glow discharge device 70 in operating devices in accordance with exemplary embodiments will be described in more detail.

FIG. 3 shows a circuit diagram of an anti-glow discharge device 70 in an operating device in accordance with one exemplary embodiment. The anti-glow discharge device 70 comprises a switching means 71. The switching means 71 can be arranged on the secondary side 62 of the operating device. The switching means 71 can comprise a transistor, for example a FET or another power switch. The switching means 71 can connect the radio interference suppression capacitor 59 conductively to a ground potential P0 when it is switched to an on state.

The switching means 71 can be controlled in such a way that a resistance of the switching means 71 is controlled depending on an operating state. The resistance of the switching means 71 can be reduced selectively when the luminaire 40 is switched on and/or when the operating device 50 is not in a standby mode and provides energy to the illuminant. As a result, the radio interference suppression capacitor 59 is connected in order to discharge interference signals to the ground potential P0. The resistance of the switching means 71 can be increased selectively when the luminaire 40 is switched off and/or when the operating device 50 is in a standby mode. As a result, the switching means 71 can be switched to an off state. The radio interference suppression capacitor 59 can thus be disconnected in order to suppress glow discharge of the illuminant.

The switching means 71 can be provided in such a way that it is switched to the on state depending on a voltage or a current at the output of the operating device. For this purpose, for example, a gate of the switching means 71 can be coupled to an operating voltage of the secondary side 62.

The switching means 71 can be provided in such a way that it is controlled by a microcontroller, a controller, a processor or another integrated semiconductor circuit. A gate of the switching means 71 can be coupled to a microcontroller, which is arranged on the secondary side 62 of the operating device 50. The microcontroller can be coupled to the secondary-side coil 55 in order to be supplied energy thereby. Correspondingly, the microcontroller controls the switching means 71 so that it is switched to an on state only when the microcontroller of the secondary side is also supplied energy. As a result, it is possible to ensure that the radio interference suppression element is disconnected selectively when the luminaire is switched off and/or the operating device is in a standby mode.

FIG. 4 shows a circuit arrangement of components of an operating device 50 in accordance with one exemplary embodiment. In this case, for illustrative purposes, a converter having a flyback converter topology is illustrated. Other types of converter can be used. In the case of the converter, a switching means 58 is activated in order to store energy in the primary-side coil 54 (i.e. in order to charge the primary-side coil 54) or in order to transmit energy from the primary-side coil 54 to the secondary-side coil 55 (i.e. to discharge the primary-side coil 54). The switching means 58 can be controlled by a microcontroller 69 on the primary side of the operating device 50. Instead of a microcontroller 69, a controller, a processor or another integrated semiconductor circuit can also be used. A charging capacitor 66 can be charged on the secondary side via a diode 65, which is connected to the secondary-side coil 55. Current can be output to the illuminant via output connections 67, 68 of the operating device 50. The microcontroller 69 can control the switching means 58 in such a way that a constant current for supplying LEDs is generated from a rectified supply voltage at inputs 63, 64 of the converter.

A further microcontroller 72 is provided on the secondary side of the operating device. The further microcontroller 72 can be supplied energy by an operating voltage of the secondary side. The further microcontroller 72 can be configured to switch the switching means 71 from an off state to an on state when energy for the illuminant is provided by the output connections 67, 68. The further microcontroller 72 can be configured in such a way that the switching means 71 is switched to an off state when the luminaire is switched off and/or the operating device is in a standby mode.

The further microcontroller 72 is isolated from the microcontroller 69 of the primary side and can implement further control functions. Instead of the microcontroller 72, it is also possible for a controller, a processor or another integrated semiconductor circuit to be used.

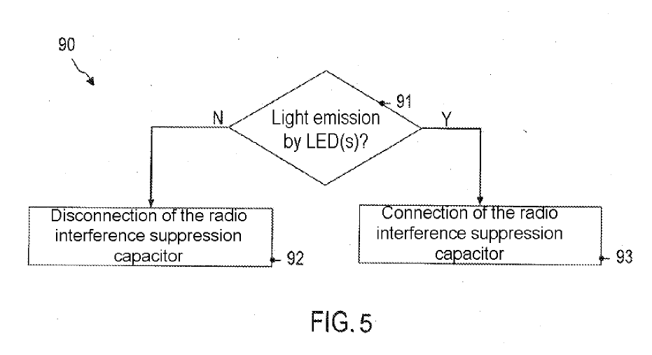

FIG. 5 shows a flowchart of a method 90 in accordance with one exemplary embodiment. The method 90 can be implemented automatically by the operating device 50 in accordance with one exemplary embodiment. In the method, a glow discharge of an illuminant can be suppressed depending on an operating state.

In step 91, it is determined whether a light emission takes place via LEDs. For this purpose, it is possible to determine whether the luminaire is switched on. An operating voltage on a secondary side of the operating device can be monitored. Other criteria can be checked in order to determine whether glow discharge of the LEDs should be suppressed.

In step 92, a radio interference suppression element, for example a radio interference suppression capacitor, can be disconnected when the glow discharge is intended to be suppressed. This can be achieved by virtue of the fact that a line path between the radio interference suppression element and a ground potential has a high resistance, at least for signals at the supply voltage frequency. A switching means between the radio interference suppression element and the ground potential can be switched to an off state. The switching means can be configured in such a way that it automatically transfers to a blocking state when no control signal is present at a gate of the switching means. The switching means can be switched to the off state by virtue of no control signal for controlling the switching means being output.

In step 93, the radio interference suppression element can be connected when the glow discharge of the illuminant does not need to be suppressed, for example when the luminaire is switched on. This can be achieved by virtue of the fact that a line path between the radio interference suppression element and a ground potential has a low resistance, at least for frequencies in a radio interference suppression range. A switching means between the radio interference suppression element and the ground potential can be switched to an on state.

While operating devices and methods in accordance with exemplary embodiments have been described in detail with reference to the figures, modifications in other exemplary embodiments can be realized. While exemplary embodiments have been described in detail by way of example in which the radio interference suppression element is in the form of a capacitor, other configurations and/or arrangements of the radio interference suppression element can also be used.

Operating devices and methods in accordance with exemplary embodiments can be used in particular for operating luminaires which comprise LEDs, without being restricted to this.

1. An operating device for an illuminant (42), comprising:
a radio interference suppression element (59), and
an anti-glow discharge device (70; 71, 72; 73) for suppressing glow discharge of the illuminant (42), said anti-glow discharge being coupled to the radio interference suppression element (59).

2. The operating device as claimed in claim 1, wherein the anti-glow discharge device (70; 71, 72; 73) is configured to influence a current flow to or from the radio interference suppression element (59).

3. The operating device as claimed in claim 1, wherein the anti-glow discharge device (70; 71, 72; 73) comprises a controllable switching means (71) which is connected in series with the radio interference suppression element (59), between the radio interference suppression element (59) and ground.

4. The operating device as claimed in claim 3, wherein the operating device (50) is configured to switch the controllable switching means (71) to an on state in a manner dependent on operating state.

5. The operating device as claimed in claim 3, wherein the controllable switching means (71) is configured to be switched to an on state by a microcontroller (72) or a voltage of a secondary side (62) of the operating device (50).

6. The operating device as claimed in claim 1, wherein the anti-glow discharge device (70; 71, 72; 73) comprises an element (73) having a frequency-dependent impedance (80).

7. The operating device as claimed in claim 6, wherein the element (73) has a greater magnitude of the impedance (81) in the case of a supply voltage frequency (83) of the operating device (50) than for a frequency in the radio interference suppression range (84).

8. The operating device as claimed in claim 1, wherein the operating device (50) has a primary side (61) and a secondary side (62), wherein the radio interference suppression element (59) is a radio interference suppression capacitor between the primary side and the secondary side (62).

9. The operating device as claimed in claim 8, wherein the anti-glow discharge device (70; 71, 72; 73) is arranged on the secondary side (62) of the operating device (50).

10. The operating device as claimed in claim 1, wherein the operating device (50) is in the form of an LED converter.

11. A lighting system, comprising an operating device (50) as claimed in claim 1, a supply source (10) connected to the operating device (50), and an illuminant (42) connected to the operating device (50).

12. A method for suppressing glow discharge of an illuminant (42) which is coupled to an operating device (50), wherein the operating device (50) has a radio interference suppression element (59), wherein the method comprises:
influencing a current flow to or from the radio interference suppression element (59) in order to suppress the glow discharge.

13. The method as claimed in claim 12, which is implemented using an operating device comprising:
a radio interference suppression element (59), and
an anti-glow discharge device (70; 71, 72; 73) for suppressing glow discharge of the illuminant (42), said anti-glow discharge being coupled to the radio interference suppression element (59).
